(19) United States
(12) Patent Application Publication
(10) Pub. No.: US 2026/0367987 A1
(43) Pub. Date: Nov. 19, 2026

(54) ENHANCED MACHINE LEARNING PLATFORM USAGE

(71) Applicant: Coupang Corp., Seoul (KR)

(72) Inventors: Shengmin ZHAN, Seattle, WA (US); Haitao JIANG, Seattle, WA (US)

(21) Appl. No.: 19/209,248

(22) Filed: May 15, 2025

(51) Int. Cl. G06F 9/50

(52) U.S. Cl. CPC G06F 9/505; G06F 2209/508

(57) ABSTRACT

Methods, systems, and apparatus, including computer programs encoded on computer storage media, for enhanced machine learning platform usage. One of the methods includes generating one or more usage identifiers for a first machine learning workload; allocating, from a set of one or more compute resources, a first compute resource for the first machine learning workload; generating output indicating (i) operations performed by the first compute resource and (ii) the usage identifiers for the first machine learning workload; and computing, using the indicated operations and generated output, a usage data set for the first machine learning workload.

### BACKGROUND

Machine learning computations, either during a training phase or inference phase of one or more machine learning models, requires significant computer processing capabilities. For example, image generation models can use 2.907 kilowatt-hours (kWh) per 1,000 inferences while training large language models (LLM), like GPT-3, can use around 1,300 megawatt-hours (MWh). With ever-growing use of machine learning models, existing compute resources can fail to process all requested machine learning computations which can cause delays both in machine learning model training and inferences.

### SUMMARY

In general, one innovative aspect of the subject matter described in this specification can be embodied in methods that include generating one or more usage identifiers for a first machine learning workload, allocating, from a set of one or more compute resources, a first compute resource for the first machine learning workload, generating output indicating (i) operations performed by the first compute resource and (ii) the usage identifiers for the first machine learning workload, and computing, using the indicated operations and generated output, a usage data set for the first machine learning workload. Other embodiments of this aspect include corresponding computer systems, apparatus, and computer programs recorded on one or more computer storage devices, each configured to perform the methods.

The foregoing and other embodiments can each optionally include one or more of the following features, alone or in combination. In particular, one embodiment includes all the following features in combination. Feature 1: Methods include allocating, using the computed usage data set for the first machine learning workload, a second compute resource for the first machine learning workload that is different from the first compute resource. Feature 2: Generating the one or more usage identifiers for the first machine learning workload comprises: detecting a first item of information indicating the first machine learning workload, and generating, using the detected first item of information, an identifier of the usage identifiers. Feature 3: Generating the one or more usage identifiers for the first machine learning workload comprises: generating the one or more usage identifiers for a set of computations to be performed for an inference or training process of a first machine learning model. Feature 4: Allocating the first compute resource for the first machine learning workload comprises: allocating a graphics processing unit (GPU) for the first machine learning workload. Feature 5: Generating the output indicating (i) the operations performed by the first compute resource and (ii) the usage identifiers for the first machine learning workload comprises: generating one or more identifying textual data segments, and generating the output to include the one or more identifying textual data segments immediately before or after textual data segments indicating the operations performed by the first compute resource. Feature 6: Methods include generating one or more second usage identifiers for a second machine learning workload, wherein the second usage identifiers are different than the usage identifiers for the first machine learning workload, and wherein the second machine learning workload is different than the first machine learning workload. Feature 7: Methods include detecting that the first compute resource is idle; and in response to detecting that the first compute resource is idle, allocating the first compute resource for the second machine learning workload.

The technology described in this specification can be implemented so as to realize one or more of the following advantages. For example, using identifiers to compute usage data for one or more particular machine learning workloads allows one or more compute resources to be assigned for processing one or more different processing workloads. Usage, instead of reserved time, can be the basis for usage-based statistics provided to a user. This can effectively increase a number of compute resources that are available because compute resources may not be off limits simply because one or more users have reserved processing time. Rather, compute resources currently in use can be limited to the current workload being processed but can process other workloads as soon as the current workload is complete. Workload-based identifiers allow such usage optimization to occur.

In some cases, workloads can be dynamically allocated to one or more compute resources. For example, if a user requests a compute resource for processing a machine learning workload (such as an inference or training operation), instead of reserving one or more compute resources sufficient for the processing, a system can wait until usage is requested and then dynamically allocate one or more compute resources that are available at that time. If a user requests a compute resource for a first workload and immediately uses a first set of one or more compute resources, but there is a processing gap in the first workload—e.g., due to program failure, troubleshooting, bug fixing, among other reasons—a system can dynamically assign one or more other workloads (that request compute resources or that have been waiting for available resources) to the first set of one or more compute resources. Such dynamic allocation can help optimize available compute resources in cases where requested compute resources are not being used. Using identifiers to compute usage data for one or more particular machine learning workloads can unify different machine learning workload resources, such as storage, graphics processing unit (GPU), central processing unit (CPU), and networking elements. Actions can be performed in response to processing data indicating which workloads use one or more types or amounts of resources. Actions can include allocation of one or more workloads, visual representation on a screen of a user, generating an interface that includes a representation of the processed data, receiving input from a user in response to a representation of the processed data, or a combination of these, among others.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 shows an example platform system.

FIG. 2 is a flowchart of an example process for enhanced machine learning platform usage.

FIG. 3 is a diagram illustrating an example of a computing system.

Like reference numbers and designations in the various drawings indicate like elements.

### DETAILED DESCRIPTION

This specification describes technologies for enhanced machine learning platform usage. These technologies generally involve allocating compute resources for one or more machine learning workloads and generating usage data using one or more identifiers. Usage data can be used to more efficiently allocate available compute resources by dynamically allocating resources, at a given time, to workloads that require compute resources at the given time and away from workloads that do not currently require compute resources at the given time. Usage data can be generated for one or more machine learning workloads using usage identifiers.

During processing, allocated compute resources can be used to generate output that includes indications of operations performed and a set of one or more generated usage identifiers. The indicated operations and the generated usage identifiers can be used to compute a usage data set, which can indicate whether one or more compute resources are under, or over, allocated. Re-allocation processes can be performed using the computed usage data set for one or more compute resources.

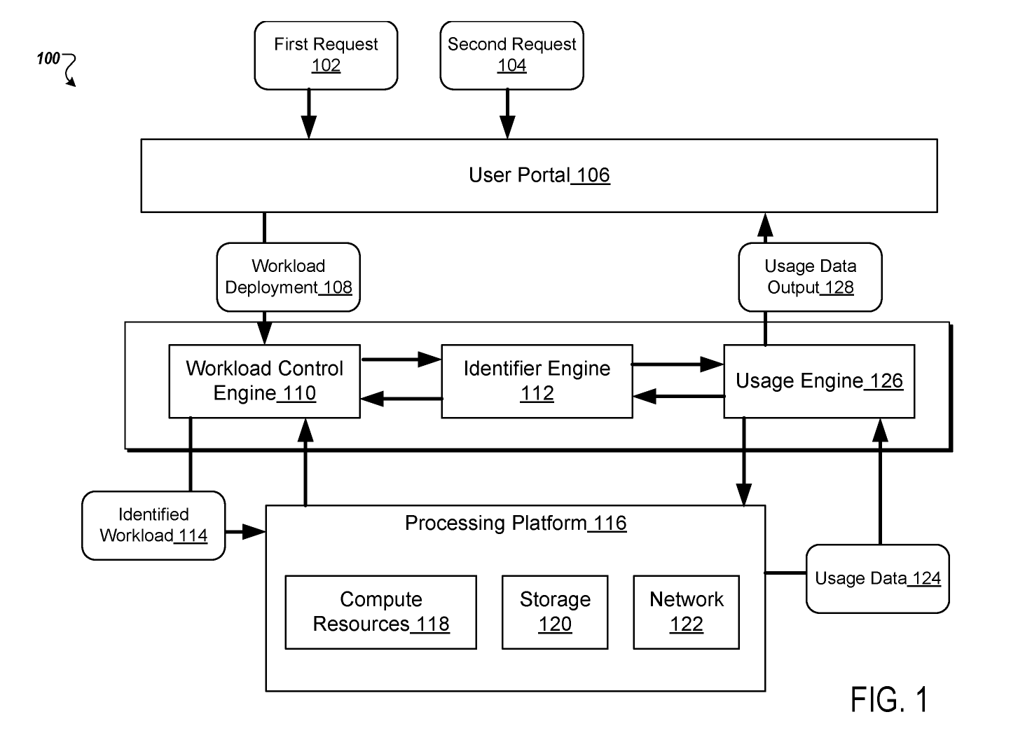

FIG. 1 shows an example platform system 100. The system 100 includes a user portal 106, a workload control engine 110, an identifier engine 112, a processing platform 116, and a usage engine 126. The system 100 can use the identifier engine 112 to generate one or more identifiers for one or more workloads deployed by the workload control engine 110. The identifiers can be used by the processing platform 116 to generate usage data 124 that indicates one or more identifiers for one or more workloads. The usage engine 126 can use the usage data 124 to generate workload-specific usages which can be provided to a user or used for one or more autonomous, or semi-autonomous, processes, such as dynamic re-allocation of compute resources.

One or more users can deploy workloads using the system 100. For example, users operating the user portal 106 can generate requests for one or more compute resources. In some implementations, a user logs into an account on the user portal 106 that is linked to a logging in user. A user can request to deploy a workload. A workload can include processing performed by one or more computing elements, such as training or inference operations for a machine learning model. In a request, or subsequent interaction, a user can provide workload details, such as workload name, resources required or preferred, other relevant information, or a combination of these.

In the example of FIG. 1, the user portal 106 receives a first request 102 and a second request 104. In some implementations, the user portal 106 includes an interface for users to view usage, billing, account information, among other information. The user portal 106 can include an interface to request one or more compute resources to perform one or more operations, e.g., operations for a training or inference of a machine learning model. In some implementations, the user portal 106 includes a web-based interface (e.g., interfaces based on React, Angular, or Vue.js). Users operating the user portal 106 can manage workloads, view usage and billing information, perform relevant actions, among other operations.

The user portal 106 can provide a workload deployment 108 to the workload control engine 110. The workload deployment 108 can include information of one or more requests, such as the first request 102. In some implementations, the workload control engine 110 performs application management. The workload control engine 110 can include a module for managing or provisioning workloads or resources.

In some implementations, the workload control engine 110 includes a modular component built using containerization (e.g., Docker) and/or orchestration tools (e.g., Kubernetes). The workload control engine 110 can manage a lifecycle of processing tasks, such as one or more machine learning workloads. A lifecycle can include deployment, scaling, termination, or a combination of these.

The identifier engine 112 generates one or more identifiers for one or more workloads. The one or more identifiers can include unique tags, such as alphanumeric tags, that uniquely identify one or more workloads to be processed. For example, the identifier engine 112 can generate one or more identifiers for the workload deployment 108. In some cases, the workload control engine 110 can request that the identifier engine 112 generate one or more identifiers based on the workload control engine 110 receiving the workload deployment 108.

In some cases, the workload control engine 110 parses the workload deployment 108 and transmits a request to generate one or more identifiers to the identifier engine 112 in response to detecting one or more values of information within the workload deployment 108. For example, the workload control engine 110 can compare the workload deployment 108 to one or more previously requested deployed workloads. In response to the workload control engine 110 determining that the workload deployment 108 does not represent a previously deployed workload—e.g., using a result of the comparison—the workload control engine 110 can transmit a request to generate one or more identifiers to the identifier engine 112.

In some implementations, the identifier engine 112 includes a centralized component that is built using a database management system (e.g., MySQL, PostgreSQL). The identifier engine 112 can manage one or more identifiers that can be used to track usage and generate usage-based output, such as billing information. The identifiers can help ensure accurate usage tracking.

In some implementations, identifiers generated by the identifier engine 112 include one or more of the following: (i) an identifier for a user; (ii) an identifier for a department or team within the user’s organization; (iii) an identifier for a workload, e.g., operating an application of interest to a user; or (iv) an identifier for an account of a user. In some cases, a user can have multiple, different, accounts.

The workload control engine 110 can communicate with the identifier engine 112. The workload control engine 110 can receive an identifier for the workload deployment 108. The workload control engine 110 can attach the received identifier to the workload deployment 108—e.g., by inserting the received identifier into a sequence of code configured to control one or more elements of the processing platform 116. The workload control engine 110 can provide an identified workload 114 to the processing platform 116. The identified workload 114 can include the received identifier. The identified workload 114 can include a sequence of code configured to control one or more elements of the processing platform 116.

The processing platform 116 can include a Kubernetes-based cluster. The processing platform 116 can deploy and/or manage one or more workloads, e.g., machine learning workloads. The processing platform 116 can include a set of node machines for running containerized workloads.

The processing platform 116 receives the identified workload 114. The processing platform 116 can deploy one or more of compute resources 118 to process computations of the identified workload 114, e.g., computations of a learning or inference operation for one or more machine learning models. Storage 120 or a network 122 can be used in combination with the compute resources 118 to process one or more workloads, e.g., to store intermediate or final output values or communicate data to one or more users or other elements.

The compute resources 118 can include one or more GPUs and/or CPUs. The processing platform 116 can include elements of cloud computing. The processing platform 116 can include one or more computers configured to perform computations of one or more workloads, such as the identified workload 114.

The usage engine 126 receives the usage data 124 from the processing platform 116. For one or more operations performed for the identified workload 114, the processing platform 116 can generate output that includes one or more identifiers for the identified workload 114 such that the usage engine 126 can extract workload specific usage data from the usage data 124.

In some cases, the usage data 124 includes one or more logs generated by processes performed by the processing platform 116. Logs can include plaintext output indicating one or more operations performed by the processing platform 116. In some cases, the usage engine 126 collects the usage data 124. In some cases, the processing platform 116 provides the usage data 124.

The usage engine 126 can include a module for calculating and processing usage and/or billing data. The usage engine 126 can include a component for collecting and aggregating usage data from one or more sources, e.g., one or more compute resources of the compute resources 118. The usage engine 126 can include a distributed component built using a messaging queue (e.g., Apache Kafka, RabbitMQ). The usage engine 126 can include a time-series database (e.g., InfluxDB, OpenTSDB). The usage engine 126 can collect and process usage data from one or more sources.

In some implementations, the usage engine 126 uses a distributed architecture to collect usage data from one or more sources. The usage engine 126 can include an architecture configured to collect metrics from platform APIs, e.g., Kubernetes APIs. The usage engine 126 can collect information, such as usage of central processing, graphics processing, memory, storage, or a combination of these.

In some implementations, the usage engine 126 parses data generated by the processing platform 116. For example, the usage engine 126 can parse one or more container logs. The usage engine 126 can collect logs from one or more containers operating one or more elements of the processing platform 116, such as the compute resources 118, the storage 120, or the network 122. The usage engine 126 can parse workload logs or system logs.

In some implementations, the usage engine 126 collects custom metrics from the processing platform 116. For example, the usage engine 126 can collect metrics for one or more machine learning models being processed by the processing platform 116. The usage engine 126 can collect model performance metrics, data processing metrics, or a combination of these.

In some implementations, the usage engine 126 collects usage metrics indicating usage of a graphics processing unit (GPU). The compute resources 118 can include one or more GPUs and/or CPUs. Usage metrics indicating usage of a GPU can include one or more of the following: (i) GPU Utilization which can include a percentage of GPU resources utilized; (ii) GPU Memory Usage which can include an amount of GPU memory allocated and/or used; or (iii) GPU Compute Usage: which can include a number of GPU compute cycles utilized.

In some implementations, the usage engine 126 collects data from the processing platform 116 and processes the collected data while one or more processes are being performed by the processing platform 116 and/or the usage engine 126. The usage engine 126 can perform one or more of the following operations: (i) aggregate usage data which can include combining usage data from one or more sources; (ii) apply identifiers which can include attaching identifiers generated by the identifier engine 112 to the aggregated usage data; or (iii) calculate billing information which can include calculating a billing amount based on usage data and identifiers, e.g., applying one or more different billing rates to usage of one or more elements of the processing platform 116 by a given workload.

In some implementations, the usage engine 126 includes a component built using a data processing engine (e.g., Apache Spark, Apache Flink). The usage engine 126 can process usage data. The usage engine 126 can calculate billing information, e.g., based on one or more identifiers indicating billing labels.

In some implementations, the usage engine 126 continuously or periodically monitors the processing platform 116. The usage engine 126 can aggregate and process one or more items of aggregated data. The usage engine 126 can track metrics such as GPU, pod, CPU, memory, storage, other relevant resources, or a combination of these. In the context of Kubernetes, a pod can be a smallest deployable unit that can be created and managed. A pod can represent a single instance of a running process in a cluster and can include one or more containers.

The usage engine 126 generates the usage data output 128. In some implementations, the usage engine 126 reports usage and billing. The usage engine 126 can report aggregated usage data to the user portal 106. The usage engine 126 can process usage data and calculate billing information based on one or more identifiers included in, or corresponding to, the usage data 124. The usage engine 126 can store calculated billing information. The usage engine 126 can update the user portal 106 while performing one or more other operations or while the processing platform 116 is performing one or more operations for the identified workload 114 or another workload. A user that requests processing for a given workload can track usage by the given workload in real-time using the user portal 106.

In some implementations, the processing platform 116 includes elements configured to provide data that is processed by the usage engine 126. For example, the elements can include one or more of: (i) a data center GPU manager (DCGM); (ii) a container advisory, e.g., that collects, aggregates, processes, and/or exports metrics such as CPU/GPU usage, memory usage, filesystem statistics, and/or network statistics for one or more containers running on a given node; or (iii) a node agent, e.g., a kubelet that runs on each node in a cluster.

In some implementations, the user portal 106 is updated with the latest usage information. For example, the usage engine 126 can provide the usage data output 128 which can represent usage information for the identified workload 114 at any of the following times: (i) before the identified workload 114 is processed using the processing platform 116, (ii) while the identified workload 114 is being processed using the processing platform 116, or (iii) after the identified workload 114 has been processed using the processing platform 116. Usage information can include billing information—e.g., billing information for one or more specific workloads based on a usage of the corresponding specific workloads. A user can access the user portal 106 to view current and/or historical usage data.

In some implementations, the system 100 dynamically allocates resources, e.g., to optimize resource usage. For example, the usage data 124 can be used by the workload control engine 110 to adjust an allocation of one or more compute resources. In some cases, in addition to the first request 102, the system 100 can receive a second request 104. The second request 104 can request one or more compute resources to perform one or more operations. The processing platform 116 may have not yet started processing the identified workload 114 or the identified workload 114 may be halted for some reason (e.g., troubleshooting, code error, system malfunction, user interrupt, among others). The workload control engine 110 can detect when one or more resources of the processing platform 116 are idle and dynamically allocate other workloads for processing by the idle resources. For example, the workload control engine 110 can allocate one or more workloads for the second request 104 to one or more idle resources that were reserved for, or recently halted part way through, processing the identified workload 114.

In some cases, dynamic allocation can be performed based on workload priority. For example, the system 100 can identify one or more workload priorities. Workload priorities can be generated based on one or more workload features, such as an importance level, processing requirements, estimated length of computations, uptime, downtime, user specified priority value, user account status, or a combination of these, among others. The system 100 can generate a workload priority by combining one or more values indicating one or more workload features. The system 100 can allocate one or more resources using a priority indication. For example, the system 100 can preempt a lower priority workload from being allocated to a resource that is currently allocated to a higher priority workload. The system 100 can assign a higher priority workload to a resource that is assigned to a lower priority workload. The system 100 can generate or receive priority information for one or more workloads and allocate the one or more workloads using the generated or received priority information—e.g., to prioritize workloads with a higher priority over workloads with a lower priority.

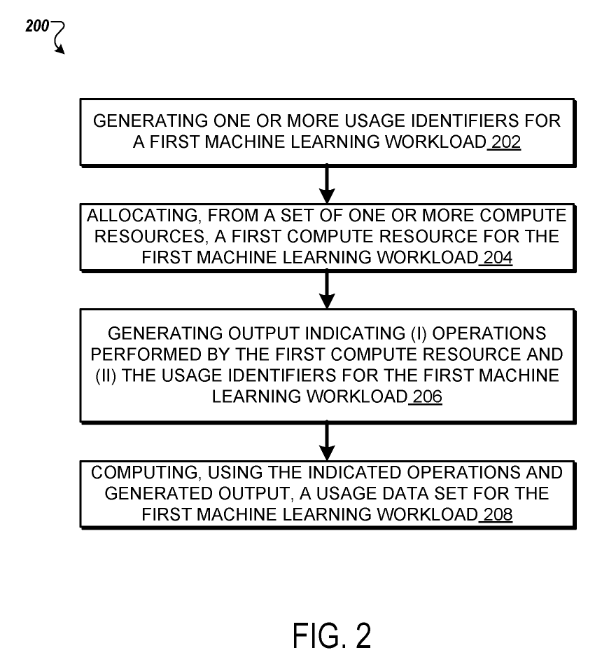

FIG. 2 is a flowchart of an example process 200 for enhanced machine learning platform usage. For convenience, the process 200 will be described as being performed by a system of one or more computers, located in one or more locations, and programmed appropriately in accordance with this specification. For example, a platform system, e.g., the system 100 of FIG. 1, appropriately programmed, can perform the process 200.

The process 200 includes generating one or more usage identifiers for a first machine learning workload (202). For example, the identifier engine 112 can generate one or more identifiers for a workload indicated by the workload deployment 108 and the first request 102. The first machine learning workload can include one or more computations to be performed by a computer, such as computations to perform a training or inference operation of a machine learning model.

In some implementations, generating the one or more usage identifiers for the first machine learning workload includes detecting a first item of information indicating the first machine learning workload; and generating, using the detected first item of information, an identifier of the usage identifiers. For example, the workload control engine 110 can parse data of the workload deployment 108. The workload control engine 110 can detect one or more items of information in the workload deployment 108. The one or more items of information can indicate a workload name, amount or type of resources required, or other relevant information. Items of information can be provided by a user interacting with one or more interfaces of the user portal 106. Identifiers can include plain text representations of the items of information or hash values, or other values, representing the items of information. Hash values can be generated by a hash engine that can reduce a memory size for items of information, e.g., to reduce a memory size of output generated by the processing platform 116 that includes the one or more generated identifiers.

In some implementations, generating the one or more usage identifiers for the first machine learning workload includes generating the one or more usage identifiers for a set of computations to be performed for an inference or training process of a first machine learning model. For example, the identifier engine 112 can receive data indicating a workload for an inference or training process of a first machine learning model. The first machine learning model can be configured to perform an operation, such as image classification, optical character recognition, generative modeling, or the like. Computations identified by the identifier engine 112 as a workload can include inference computations or training computations for an inference of training operation of the first machine learning model.

The process 200 includes allocating, from a set of one or more compute resources, a first compute resource for the first machine learning workload (204). For example, the workload control engine 110 or the processing platform 116 can allocate one or more compute resources of the compute resources 118 to process the identified workload 114. In some cases, the workload control engine 110 computes resources for one or more workloads. In some cases, the processing platform 116 allocates one or more resources, e.g., the compute resources 118, the storage 120, the network 122, or a combination of these, among others. The processing platform 116 can include a system, such as Kubernetes, that performs allocation of one or more resources for one or more workloads.

In some implementations, the workload control engine 110 or the processing platform 116 allocates one or more CPUs or GPUs for processing one or more workloads. For example, the workload control engine 110 can determine, using information of the workload deployment 108, what resources to allocate for the identified workload 114. The resources can include, e.g., more GPUs for processing in which graphics processing is more efficient and more CPUs for processing in which CPU is more efficient.

The process 200 includes generating output indicating (i) operations performed by the first compute resource and (ii) the usage identifiers for the first machine learning workload (206). For example, the processing platform 116 can generate the usage data 124. In some cases, the usage engine 126 can generate the usage data 124 by extracting one or more logs generated by the processing platform 116 processing the identified workload 114. The usage data 124 can include output indicating one or more computations performed by the processing platform 116. Each of the one or more computations can be associated with one or more identifiers corresponding to the identified workload 114. The identifiers can be generated by the identifier engine 112.

In some implementations, generating the output indicating (i) the operations performed by the first compute resource and (ii) the usage identifiers for the first machine learning workload includes generating one or more identifying textual data segments; and generating the output to include the one or more identifying textual data segments immediately before or after textual data segments indicating the operations performed by the first compute resource. For example, the processing platform 116 can generate output in a textual format where lines of text indicate one or more identifiers or operations. At least a portion of the output generated by the processing platform 116 can be included in the usage data 124. A line of text in output can include an identifier and another line of text in output can include information of a computation performed by the processing platform 116.

The process 200 includes computing, using the indicated operations and generated output, a usage data set for the first machine learning workload (208). For example, the usage engine 126 can generate the usage data output 128. The usage data output 128 can indicate usage metrics or billing information for one or more workloads. The usage engine 126 can generate the usage data output 128 while performing usage processing for one or more other workloads or while the processing platform 116 is performing one or more computations for one or more other workloads—e.g., the usage engine 126 can process the usage data 124 and generate output for display on a portal, such as the user portal 106. The usage data can reflect a most recent usage amount when a user logs in to the user portal 106.

In some implementations, the process 200 includes allocating, using the computed usage data set for the first machine learning workload, a second compute resource for the first machine learning workload that is different from the first compute resource. For example, the system 100 can detect a halt in the processing of the identified workload 114. A halt can occur if the start of processing is delayed or if processing stops part of the way through (e.g., due to code error, troubleshooting, or user interrupt). In response to detecting a halt, the system 100 can re-allocate one or more compute resources used by the identified workload 114 to another workload, e.g., a workload to satisfy the second request 104. After the identified workload 114 requests to continue, the system can allocate a second compute resource, different from the first compute resource previously allocated to the identified workload 114—e.g., because the first compute resource is being used by a workload to satisfy the second request 104.

In some implementations, the process 200 includes generating one or more second usage identifiers for a second machine learning workload, wherein the second usage identifiers are different than the usage identifiers for the first machine learning workload, and wherein the second machine learning workload is different than the first machine learning workload. For example, the identifier engine 112 can generate one or more identifiers for a workload to satisfy the second request 104. The second request 104 can include a request for a set of one or more compute resources to perform a particular operation, such as train a machine learning model. The identifier engine 112 can generate one or more identifiers for a workload representing the operations to be performed for the second request 104. The generated one or more identifiers can be different than identifiers generated for other requests or workloads, such as the first request 102.

In some implementations, the process 200 includes detecting that the first compute resource is idle; and in response to detecting that the first compute resource is idle, allocating the first compute resource for the second machine learning workload. For example, the workload control engine 110 or the processing platform 116 can detect that a compute resource of the compute resources 118 is idle, e.g., a compute resource allocated to perform operations of the identified workload 114. The workload control engine 110 or the processing platform 116 can allocate another workload, such as a workload for the second request 104, to be performed by the first compute resource that is detected to be idle. An idle resource can include a resource for which processing has halted or for which processing has not yet begun—e.g., due to processing delay, user interrupt, or troubleshooting.

In some implementations, a user device is configured to interact with a system configured to perform operations corresponding to the process 200. For example, a user device can include a computer or smartphone that provides one or more requests, e.g., the first request 102, using the user portal 106. The user device can be located in one area and one or more computers configured to interact with the user device can be located in the same, or another, area.

In this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

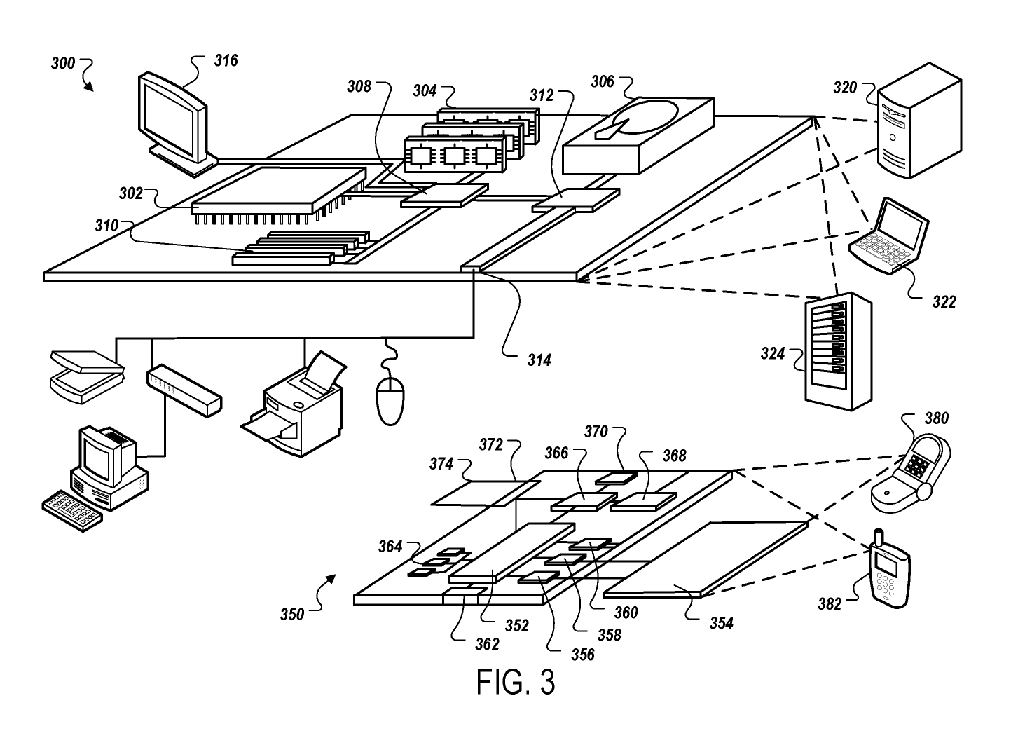

FIG. 3 is a diagram illustrating an example of a computing system used for enhanced platform usage. The computing system includes computing device 300 and a mobile computing device 350 that can be used to implement the techniques described herein. For example, one or more components of the system 100 could be an example of the computing device 300 or the mobile computing device 350, such as a computer system implementing the processing platform 116, devices that access information from the processing platform 116, or a storage unit that accesses or stores information regarding the operations performed by the processing platform 116.

The computing device 300 is intended to represent various forms of digital computers, such as laptops, desktops, workstations, personal digital assistants, servers, blade servers, mainframes, and other appropriate computers. The mobile computing device 350 is intended to represent various forms of mobile devices, such as personal digital assistants, cellular telephones, smart-phones, mobile embedded radio systems, radio diagnostic computing devices, and other similar computing devices. The components shown here, their connections and relationships, and their functions, are meant to be examples only, and are not meant to be limiting.

The computing device 300 includes a processor 302, a memory 304, a storage device 306, a high-speed interface 308 connecting to the memory 304 and multiple high-speed expansion ports 310, and a low-speed interface 312 connecting to a low-speed expansion port 314 and the storage device 306. Each of the processor 302, the memory 304, the storage device 306, the high-speed interface 308, the high-speed expansion ports 310, and the low-speed interface 312, are interconnected using various busses, and may be mounted on a common motherboard or in other manners as appropriate. The processor 302 can process instructions for execution within the computing device 300, including instructions stored in the memory 304 or on the storage device 306 to display graphical information for a GUI on an external input/output device, such as a display 316 coupled to the high-speed interface 308. In other implementations, multiple processors and/or multiple buses may be used, as appropriate, along with multiple memories and types of memory. In addition, multiple computing devices may be connected, with each device providing portions of the operations (e.g., as a server bank, a group of blade servers, or a multi-processor system). In some implementations, the processor 302 is a single threaded processor. In some implementations, the processor 302 is a multi-threaded processor. In some implementations, the processor 302 is a quantum computer.

The memory 304 stores information within the computing device 300. In some implementations, the memory 304 is a volatile memory unit or units. In some implementations, the memory 304 is a non-volatile memory unit or units. The memory 304 may also be another form of computer-readable medium, such as a magnetic or optical disk.

The storage device 306 is capable of providing mass storage for the computing device 300. In some implementations, the storage device 306 may be or include a computer-readable medium, such as a floppy disk device, a hard disk device, an optical disk device, or a tape device, a flash memory or other similar solid-state memory device, or an array of devices, including devices in a storage area network or other configurations. Instructions can be stored in an information carrier. The instructions, when executed by one or more processing devices (for example, processor 302), perform one or more methods, such as those described above. The instructions can also be stored by one or more storage devices such as computer- or machine readable mediums (for example, the memory 304, the storage device 306, or memory on the processor 302).The high-speed interface 308 manages bandwidth-intensive operations for the computing device 300, while the low-speed interface 312 manages lower bandwidth-intensive operations. Such allocation of functions is an example only. In some implementations, the high speed interface 308 is coupled to the memory 304, the display 316 (e.g., through a graphics processor or accelerator), and to the high-speed expansion ports 310, which may accept various expansion cards (not shown). In the implementation, the low-speed interface 312 is coupled to the storage device 306 and the low-speed expansion port 314. The low-speed expansion port 314, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

The computing device 300 may be implemented in a number of different forms, as shown in the figure. For example, it may be implemented as a standard server 320, or multiple times in a group of such servers. In addition, it may be implemented in a personal computer such as a laptop computer 322. It may also be implemented as part of a rack server system 324. Alternatively, components from the computing device 300 may be combined with other components in a mobile device, such as a mobile computing device 350. Each of such devices may include one or more of the computing device 300 and the mobile computing device 350, and an entire system may be made up of multiple computing devices communicating with each other.

The mobile computing device 350 includes a processor 352, a memory 364, an input/output device such as a display 354, a communication interface 366, and a transceiver 368, among other components. The mobile computing device 350 may also be provided with a storage device, such as a micro-drive or other device, to provide additional storage. Each of the processor 352, the memory 364, the display 354, the communication interface 366, and the transceiver 368, are interconnected using various buses, and several of the components may be mounted on a common motherboard or in other manners as appropriate.

The processor 352 can execute instructions within the mobile computing device 350, including instructions stored in the memory 364. The processor 352 may be implemented as a chipset of chips that include separate and multiple analog and digital processors. The processor 352 may provide, for example, for coordination of the other components of the mobile computing device 350, such as control of user interfaces, applications run by the mobile computing device 350, and wireless communication by the mobile computing device 350.

The processor 352 may communicate with a user through a control interface 358 and a display interface 356 coupled to the display 354. The display 354 may be, for example, a TFT (Thin-Film-Transistor Liquid Crystal Display) display or an OLED (Organic Light Emitting Diode) display, or other appropriate display technology. The display interface 356 may include appropriate circuitry for driving the display 354 to present graphical and other information to a user. The control interface 358 may receive commands from a user and convert them for submission to the processor 352. In addition, an external interface 362 may provide communication with the processor 352, so as to enable near area communication of the mobile computing device 350 with other devices. The external interface 362 may provide, for example, for wired communication in some implementations, or for wireless communication in other implementations, and multiple interfaces may also be used.

The memory 364 stores information within the mobile computing device 350. The memory 364 can be implemented as one or more of a computer-readable medium or media, a volatile memory unit or units, or a non-volatile memory unit or units. An expansion memory 374 may also be provided and connected to the mobile computing device 350 through an expansion interface 372, which may include, for example, a SIMM (Single In Line Memory Module) card interface. The expansion memory 374 may provide extra storage space for the mobile computing device 350, or may also store applications or other information for the mobile computing device 350. Specifically, the expansion memory 374 may include instructions to carry out or supplement the processes described above, and may include secure information also. Thus, for example, the expansion memory 374 may be provide as a security module for the mobile computing device 350, and may be programmed with instructions that permit secure use of the mobile computing device 350. In addition, secure applications may be provided via the SIMM cards, along with additional information, such as placing identifying information on the SIMM card in a non-hackable manner.

The memory may include, for example, flash memory and/or NVRAM memory (nonvolatile random access memory), as discussed below. In some implementations, instructions are stored in an information carrier such that the instructions, when executed by one or more processing devices (for example, processor 352), perform one or more methods, such as those described above. The instructions can also be stored by one or more storage devices, such as one or more computer- or machine-readable mediums (for example, the memory 364, the expansion memory 374, or memory on the processor 352). In some implementations, the instructions can be received in a propagated signal, for example, over the transceiver 368 or the external interface 362.

The mobile computing device 350 may communicate wirelessly through the communication interface 366, which may include digital signal processing circuitry in some cases. The communication interface 366 may provide for communications under various modes or protocols, such as GSM voice calls (Global System for Mobile communications), SMS (Short Message Service), EMS (Enhanced Messaging Service), or MMS messaging (Multimedia Messaging Service), CDMA (code division multiple access), TDMA (time division multiple access), PDC (Personal Digital Cellular), WCDMA (Wideband Code Division Multiple Access), CDMA2000, or GPRS (General Packet Radio Service), LTE, 5G/6G cellular, among others. Such communication may occur, for example, through the transceiver 368 using a radio frequency. In addition, short-range communication may occur, such as using a Bluetooth, Wi-Fi, or other such transceiver (not shown). In addition, a GPS (Global Positioning System) receiver module 370 may provide additional navigation- and location-related wireless data to the mobile computing device 350, which may be used as appropriate by applications running on the mobile computing device 350.

The mobile computing device 350 may also communicate audibly using an audio codec 360, which may receive spoken information from a user and convert it to usable digital information. The audio codec 360 may likewise generate audible sound for a user, such as through a speaker, e.g., in a handset of the mobile computing device 350. Such sound may include sound from voice telephone calls, may include recorded sound (e.g., voice messages, music files, among others) and may also include sound generated by applications operating on the mobile computing device 350.

The mobile computing device 350 may be implemented in a number of different forms, as shown in the figure. For example, it may be implemented as a cellular telephone 380. It may also be implemented as part of a smart-phone 382, personal digital assistant, or other similar mobile device.

A number of implementations have been described. Nevertheless, it will be understood that various modifications may be made without departing from the spirit and scope of the disclosure. For example, various forms of the flows shown above may be used, with steps re-ordered, added, or removed.

Embodiments of the invention and all of the functional operations described in this specification can be implemented in digital electronic circuitry, or in computer software, firmware, or hardware, including the structures disclosed in this specification and their structural equivalents, or in combinations of one or more of them. Embodiments of the invention can be implemented as one or more computer program products, e.g., one or more modules of computer program instructions encoded on a computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more of them.

The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal that is generated to encode information for transmission to suitable receiver apparatus.

A computer program (also known as a program, software, software application, script, or code) can be written in any form of programming language, including compiled or interpreted languages, and it can be deployed in any form, including as a stand alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a tablet computer, a mobile telephone, a personal digital assistant (PDA), a mobile audio player, a Global Positioning System (GPS) receiver, to name just a few. Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, embodiments of the invention can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Embodiments of the invention can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the invention, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this specification contains many specifics, these should not be construed as limitations on the scope of the invention or of what may be claimed, but rather as descriptions of features specific to particular embodiments of the invention. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

In each instance where an HTML file is mentioned, other file types or formats may be substituted. For instance, an HTML file may be replaced by an XML, JSON, plain text, or other types of files. Moreover, where a table or hash table is mentioned, other data structures (such as spreadsheets, relational databases, or structured files) may be used.

Particular embodiments of the invention have been described. Other embodiments are within the scope of the following claims. For example, the steps recited in the claims can be performed in a different order and still achieve desirable results.

What is claimed is:

1. A method comprising:
generating one or more usage identifiers for a first machine learning workload;
allocating, from a set of one or more compute resources, a first compute resource for the first machine learning workload;
generating output indicating (i) operations performed by the first compute resource and (ii) the usage identifiers for the first machine learning workload; and
computing, using the indicated operations and generated output, a usage data set for the first machine learning workload.

2. The method of claim 1, comprising:
allocating, using the computed usage data set for the first machine learning workload, a second compute resource for the first machine learning workload that is different from the first compute resource.

3. The method of claim 1, wherein generating the one or more usage identifiers for the first machine learning workload comprises:
detecting a first item of information indicating the first machine learning workload; and
generating, using the detected first item of information, an identifier of the usage identifiers.

4. The method of claim 1, wherein generating the one or more usage identifiers for the first machine learning workload comprises:
generating the one or more usage identifiers for a set of computations to be performed for an inference or training process of a first machine learning model.

5. The method of claim 1, wherein allocating the first compute resource for the first machine learning workload comprises:
allocating a graphics processing unit (GPU) for the first machine learning workload.

6. The method of claim 1, wherein generating the output indicating (i) the operations performed by the first compute resource and (ii) the usage identifiers for the first machine learning workload comprises:
generating one or more identifying textual data segments; and
generating the output to include the one or more identifying textual data segments immediately before or after textual data segments indicating the operations performed by the first compute resource.

7. The method of claim 1, comprising:
generating one or more second usage identifiers for a second machine learning workload, wherein the second usage identifiers are different than the usage identifiers for the first machine learning workload, and wherein the second machine learning workload is different than the first machine learning workload.

8. The method of claim 7, comprising:
detecting that the first compute resource is idle; and
in response to detecting that the first compute resource is idle, allocating the first compute resource for the second machine learning workload.

9. A system comprising:
a user device; and
one or more computers configured to interact with the user device and to perform operations comprising:
generating one or more usage identifiers for a first machine learning workload;
allocating, from a set of one or more compute resources, a first compute resource for the first machine learning workload;
generating output indicating (i) operations performed by the first compute resource and (ii) the usage identifiers for the first machine learning workload; and
computing, using the indicated operations and generated output, a usage data set for the first machine learning workload.

10. The system of claim 9, wherein the operations comprise:
allocating, using the computed usage data set for the first machine learning workload, a second compute resource for the first machine learning workload that is different from the first compute resource.

11. The system of claim 9, wherein generating the one or more usage identifiers for the first machine learning workload comprises:
detecting a first item of information indicating the first machine learning workload; and
generating, using the detected first item of information, an identifier of the usage identifiers.

12. The system of claim 9, wherein generating the one or more usage identifiers for the first machine learning workload comprises:
generating the one or more usage identifiers for a set of computations to be performed for an inference or training process of a first machine learning model.

13. The system of claim 9, wherein allocating the first compute resource for the first machine learning workload comprises:
allocating a graphics processing unit (GPU) for the first machine learning workload.

14. The system of claim 9, wherein generating the output indicating (i) the operations performed by the first compute resource and (ii) the usage identifiers for the first machine learning workload comprises:
generating one or more identifying textual data segments; and
generating the output to include the one or more identifying textual data segments immediately before or after textual data segments indicating the operations performed by the first compute resource.

15. The system of claim 9, wherein the operations comprise:
generating one or more second usage identifiers for a second machine learning workload, wherein the second usage identifiers are different than the usage identifiers for the first machine learning workload, and wherein the second machine learning workload is different than the first machine learning workload.

16. The system of claim 15, wherein the operations comprise:
detecting that the first compute resource is idle; and
in response to detecting that the first compute resource is idle, allocating the first compute resource for the second machine learning workload.

17. One or more non-transitory computer storage media encoded with computer program instructions that when executed by one or more computers cause the one or more computers to perform operations comprising:
generating one or more usage identifiers for a first machine learning workload;
allocating, from a set of one or more compute resources, a first compute resource for the first machine learning workload;
generating output indicating (i) operations performed by the first compute resource and (ii) the usage identifiers for the first machine learning workload; and
computing, using the indicated operations and generated output, a usage data set for the first machine learning workload.

18. The media of claim 17, wherein the operations comprise:
allocating, using the computed usage data set for the first machine learning workload, a second compute resource for the first machine learning workload that is different from the first compute resource.

19. The media of claim 17, wherein generating the one or more usage identifiers for the first machine learning workload comprises:
detecting a first item of information indicating the first machine learning workload; and
generating, using the detected first item of information, an identifier of the usage identifiers.

20. The media of claim 17, wherein generating the one or more usage identifiers for the first machine learning workload comprises:
generating the one or more usage identifiers for a set of computations to be performed for an inference or training process of a first machine learning model.
